(19) United States
(12) Patent Application Publication
(10) Pub. No.: US 2010/0090951 A1
(43) Pub. Date: Apr. 15, 2010

(54) MOUSE AND HEATING CIRCUIT

(75) Inventor: YUN-SHAN XIAO, Shenzhen City (CN)

Correspondence Address: PCE INDUSTRY, INC.;ATT. Steven Reiss, 288 SOUTH MAYO AVENUE, CITY OF INDUSTRY, CA, 91789, US

(73) Assignees: HONG FU JIN PRECISION INDUSTRY(ShenZhen) CO., LTD., Shenzhen City (CN); HON HAI PRECISION INDUSTRY CO., LTD., Tu-Cheng (TW)

(21) Appl. No.: 12/274,332

(22) Filed: Nov. 19, 2008

(30) Foreign Application Priority Data
Oct. 10, 2008 (CN) 200810304885.9

(51) Int. Cl. G09G 5/08; F23Q 7/00

(52) U.S. Cl. 345/163; 219/268

(57) ABSTRACT

A mouse includes an input circuit including a power terminal and a ground terminal, and a heating circuit. The heating circuit includes a switch chip, an electric heater, a thermo-sensitive element, and a resistor. The switch chip includes two input voltage terminals connected to the power terminal, a power-switch output terminal connected to a first terminal of the electrical heater, and an enable input terminal. A second terminal of the electric heater is connected to the ground terminal. The resistor is connected to the thermo-sensitive element in series between the input voltage terminal and the ground terminal, with a cathode of the thermo-sensitive connected to the input voltage terminals, an anode of the thermo-sensitive connected to the resistive element, to support a dividing voltage for the enable input terminal of the switch chip.

### BACKGROUND

1. Technical Field

The present disclosure relates to computerized mice, and more particularly, to a computerized mouse having a heating circuit.

2. Description of the Related Art

A peripheral, such as a mouse, may be used with a computer to control one or more operations of the computer. During the winter or in cold temperatures, if a user uses a mouse for a long time, the user's hand will feel cold and uncomfortable.

What is desired, therefore, is to provide a mouse which overcomes the above-mentioned problems.

### BRIEF DESCRIPTION OF THE DRAWINGS

FIG. 1 is a circuit diagram of a first exemplary embodiment of a computerized mouse.

FIG. 2 is a circuit diagram of a second exemplary embodiment of a computerized mouse.

### DETAILED DESCRIPTION

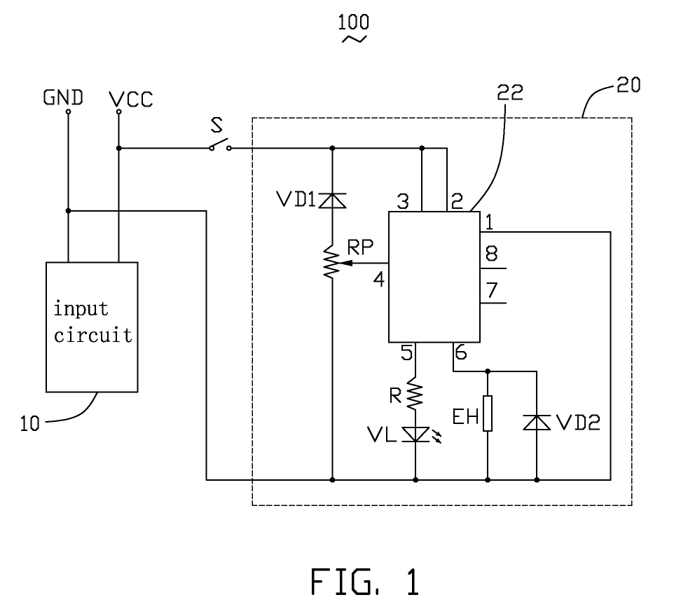

Referring to FIG. 1, a first exemplary embodiment of a computerized mouse 100 includes an input circuit 10 and a heating circuit 20. The input circuit 10 is connected to the heating circuit 20 via a switch S. When an environment around the mouse 100 is cold, the switch S is closed so as to control the heating circuit 20 to turn on to heat a surface of the mouse 100. Thus, the mouse 100 may be used to warm a user's hands when the user is operating a computer in cold weather conditions. When the environment around the mouse 100 is warm, the switch S is opened. The heating circuit 20 is turned off, so the mouse 100 has only the input function.

The heating circuit 20 includes a switch chip 22, a thermo-sensitive diode VD1 as a thermo-sensitive element, an electric heater EH, a variable resistor RP, a resistor R, a light emitting diode (LED) VL, and a diode VD2. The switch chip 22 includes a ground terminal 1, two input voltage terminals 2 and 3, an enable input terminal 4, an overcurrent output terminal 5, and three power-switch output terminals 6, 7, and 8. A shutdown reference voltage is set in the switch chip 22. The switch chip 22 is turned on when a voltage of the enable input terminal 4 is less than the shutdown reference voltage. Namely, the input voltage terminals 2 and 3 are capable of correspondingly connecting to the power-switch output terminals 6, 7, and 8 at the same time the overcurrent output terminal 5 outputs a high level signal. The switch chip 22 is turned off when the voltage of the enable input terminal 4 is greater than or equal to the shutdown reference voltage. Namely, the connection between each of the input voltage terminals 2, 3, and each of the power-switch output terminals 6, 7, and 8 is cut off, at the same time the overcurrent output terminal 5 outputs a low level signal.

The ground terminal 1 of the switch chip 22 is connected to a ground terminal GND of the input circuit 10. The input voltage terminals 2, 3 are both connected to a power terminal VCC of the input circuit 10 via the switch S. The enable input terminal 4 is connected to an adjusting terminal of the variable resistor RP. A first terminal of the variable resistor RP is connected to the ground terminal GND of the input circuit 10. A second terminal of the variable resistor RP is connected to an anode of the thermo-sensitive diode VD1. A cathode of the thermo-sensitive diode VD1 is connected to the input voltage terminals 2, 3. The overcurrent terminal 5 is connected to an anode of the LED VL via the resistor R. A cathode of the LED VL is connected to the ground terminal GND of the input circuit 10. A first terminal of the electric heater EH is connected to the power-switch output terminal 6 and a cathode of the diode VD2. A second terminal of the electric heater EH is connected to the ground terminal GND of the input circuit 10 and an anode of the diode VD2.

It may be understood that the thermo-sensitive diode VD1 has a characteristic such that a reverse resistance of the thermo-sensitive diode VD1 decreases following a rise of ambient temperature surrounding the thermo-sensitive diode VD1. It may be further understood that the reverse resistance of the thermo-sensitive diode VD1 increases following the a fall of ambient temperature surrounding the thermo-sensitive diode VD1. If a reference temperature of the mouse 100 is X Celsius degree, such as 36 Celsius degree, a resistance of the thermo-sensitive diode VD1 at 36 Celsius degree is Y according to the indication in the standard of the thermo-sensitive diode VD1. A standard of the switch chip 22 indicates that the shut voltage is Z. An equation Z=(Vcc×M1)/(M1+M2+Y) can be obtained according to voltage division relation of the thermo-sensitive diode VD1 and the variable resistor RP where M1 is a resistance between the adjusting terminal and the first terminal of the variable resistor RP. Also, M2 is a resistance between the adjusting terminal and the second terminal of the variable resistor RP. The Vcc is a voltage of the power terminal VCC of the input circuit 10.

When the ambient temperature surrounding the mouse 100 is cold, the switch S is closed. Because of the cold ambient temperature, the reverse resistance of the thermo-sensitive diode VD1 is greater than a reverse resistance of the thermo-sensitive diode VD1 at the reference temperature X Celsius degree, causing the voltage of the enable input terminal 4 of the switch chip 22 to be less than the shutdown reference voltage of the switch chip 22. Accordingly, the switch chip 22 is turned on and the input voltage terminal 2 and 3 are connected to the power-switch output terminal 6, 7, and 8 to start the electric heater EH working to heat the surface of the mouse 100. When the ambient temperature surrounding the mouse 100 continuously increases following the rise of a temperature of the electric heater EH, the reverse resistance of the thermo-sensitive diode VD1 continuously decreases. When the ambient temperature surrounding the mouse 100 heated by the electric heater EH rises to the reference temperature X Celsius degree, causing the voltage of the enable input terminal 4 of the switch chip 22 to be equal to the shutdown reference voltage of the switch chip 22. Accordingly, the switch chip 22 is turned off and a connection between the input voltage terminal 2, 3 and the power-switch output terminal 6, 7 and 8 is cut off to stop the electric heater EH working. However, because the temperature of the electric heater EH is greater than the ambient temperature surrounding the mouse 100, the ambient temperature surrounding the mouse 100 will not immediately fall but rise a little. The reverse resistance of the thermo-sensitive diode VD1 will continuously decrease. It may be appreciated that the ambient temperature of the mouse 100 may have to fall a predetermined number of degrees to actuate the thermo-sensitive diode VD1. It may further be appreciated that materials and tolerance values of thermo-sensitive diode VD1 may predetermined the number of degrees to actuate thermo-sensitive diode VD1.

During the ambient temperature surrounding the mouse 100 falls to X degree from the highest temperature, the voltage of the enable input terminal 4 of the switch chip 22 also continuously decreases until the voltage equals to the shutdown reference voltage of the switch chip 22 causing the reverse resistance of the thermo-sensitive diode VD1 to start to rise and leaving the switch chip 22 to be still turned off. The ambient temperature surround the mouse 100 continues to fall, while the reverse resistance of the thermo-sensitive diode VD1 continues to rise. Once the voltage of the enable input terminal 4 of the switch chip 22 is less than the shutdown reference voltage of the switch chip 22, the switch chip 22 is turned on and the electric heater EH is turned on again causing the ambient temperature surrounding the mouse 100 begins to rise again. The electric heater EH and the thermo-sensitive diode VD1 repeat the above-mentioned process to keep the ambient temperature surrounding the mouse 100 nearly at the reference temperature X Celsius degree.

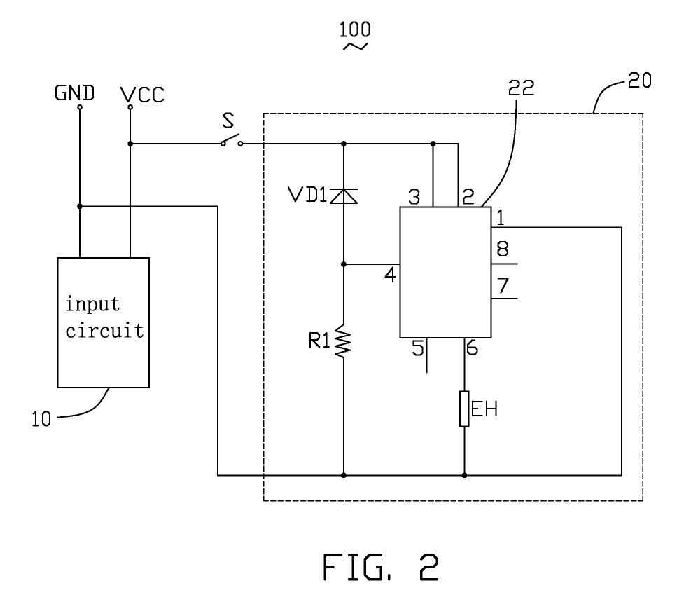

Referring to FIG. 2, in a second exemplary embodiment of a mouse, the resistor R, the LED VL, and the diode VD2 are omitted because the resistor R and the LED VL are used for indicating whether the switch chip 22 is working, and the diode VD2 is used for filtering noise. The variable resistor RP is replaced with a resistor R1. The enable input terminal of the switch chip 22 is connected to a node between the resistor R and the thermo-sensitive diode VD1.

In other embodiments, the power-switch output terminals 7, 8 of the switch chip 22 are capable of connecting to one or two electric heater to satisfy heat requirement. The thermo-sensitive diode VD1 can be replaced by a thermo-sensitive resistor.

It is to be understood, however, that even though numerous characteristics and advantages of the disclosure have been set forth in the foregoing description, together with details of the structure and function of the disclosure, the disclosure is illustrative only, and changes may be made in details, especially in matters of shape, size, and arrangement of parts within the principles of the disclosure to the full extent indicated by the broad general meaning of the terms in which the appended claims are expressed.

What is claimed is:

1. A computerized mouse comprising:
an input circuit comprising a power terminal and a ground terminal;
a heating circuit comprising a switch chip comprising two input voltage terminals connected to the power terminal of the input circuit via a switch, a power-switch output terminal, and an enable input terminal;
an electric heater configured for heating the mouse, the electric heater comprising a first terminal connected to the power-switch output terminal of the switch chip and a second terminal connected to the ground terminal of the input circuit;
a thermo-sensitive element comprising a cathode connected to the two input voltage terminals and an anode, the thermo-sensitive element configured for triggering the electric heater to heat the mouse in response to a predetermined change in temperature of an ambient environment surrounding the mouse; and
a resistive element comprising a first terminal connected to the anode of the thermo-sensitive element and a second terminal connected to the second terminal of the electric heater, wherein the enable input terminal is connected to a node of the resistive element to enable control of a shutdown reference voltage of the switch chip.

2. The computerized mouse of claim 1, wherein the resistive element is a resistor, the enable input terminal of the switch chip is connected to the first terminal of the resistor, the first terminal of the resistor is the node of the resistive element.

3. The computerized mouse of claim 1, wherein the resistive element further comprises an adjusting terminal connected to the enable input terminal, wherein the adjusting terminal is configured for adjusting a resistance of the resistive element, the adjusting terminal is the node of the resistive element.

4. The computerized mouse of claim 3, wherein the resistive element is a variable resistor.

5. The computerized mouse of claim 1, wherein the thermo-sensitive element is a thermo-sensitive diode, a cathode of the thermo-sensitive diode is connected to the two input voltage terminals of the switch chip, an anode of the thermo-sensitive diode is connected to the first terminal of the resistor.

6. The computerized mouse of claim 1, wherein the power-switch output terminal of the switch chip is grounded via a diode, an anode of the diode is connected to the ground terminal of the input circuit, a cathode of the diode is connected to the power-switch output terminal.

7. The computerized mouse of claim 1, wherein the switch chip further comprises an overcurrent output terminal, the heating circuit further comprises a light emitting (LED), the overcurrent output terminal is connected to an anode of the LED via a resistor, a cathode of the LED is connected to the ground terminal of the input circuit.

8. A computerized mouse comprising:
an input circuit comprising a power terminal and a ground terminal;
a heating circuit comprising a switch chip comprising two input voltage terminals connected to the power terminal of the input circuit, a power-switch output terminal, and an enable input terminal;
an electric heater configured for heating the mouse, the electric heater comprising a first terminal connected to the power-switch output terminal of the switch chip and a second terminal connected to the ground terminal of the input circuit;
a thermo-sensitive element; and
a resistive element;
wherein the thermo-sensitive element and the resistive element are connected in series between the input voltage terminals of the switch chip and the ground terminal of the input circuit, with a cathode of the thermo-sensitive connected to the input voltage terminals, an anode of the thermo-sensitive connected to the resistive element, to support a dividing voltage for the enable input terminal of the switch chip.

9. The computerized mouse of claim 8, wherein the power-switch output terminal of the switch chip is grounded via a diode, an anode of the diode is connected to the ground terminal of the input circuit, a cathode of the diode is connected to the power-switch output terminal.

10. The computerized mouse of claim 8, wherein the switch chip further comprises an overcurrent output terminal, the heating circuit further comprises a light emitting (LED), the overcurrent output terminal is connected to an anode of the LED via a resistor, a cathode of the LED is connected to the ground terminal of the input circuit.

11. A heating circuit configured for heating an electrical device that comprises a power terminal and a ground terminal, the heat circuit comprising:
a switch chip comprising an input voltage terminal connected to the power terminal, a power-switch output terminal, and an enable input terminal;
an electric heater comprising a first terminal connected to the power-switch output terminal and a second terminal connected to the ground terminal;
a thermo-sensitive element; and
a resistive element;
wherein the thermo-sensitive element and the resistive element are connected in series between the input voltage terminals of the switch chip and the ground terminal of the input circuit, with a cathode of the thermo-sensitive connected to the input voltage terminals, an anode of the thermo-sensitive connected to the resistive element, to support a dividing voltage for the enable input terminal of the switch chip.

12. The computerized mouse of claim 11, wherein the power-switch output terminal of the switch chip is grounded via a diode, an anode of the diode is connected to the ground terminal of the input circuit, a cathode of the diode is connected to the power-switch output terminal.

13. The computerized mouse of claim 11, wherein the switch chip further comprises an overcurrent output terminal, the heating circuit further comprises a light emitting (LED), the overcurrent output terminal is connected to an anode of the LED via a resistor, a cathode of the LED is connected to the ground terminal of the input circuit.

14. The heating circuit of claim 11, wherein the electrical device is a computerized mouse.

15. The heating circuit of claim 11, wherein the power-switch output terminal of the switch chip is grounded via a diode, an anode of the diode is connected to the ground terminal of the input circuit, a cathode of the diode is connected to the power-switch output terminal.

16. The heating circuit of claim 10, wherein the switch chip further comprises an overcurrent output terminal, the heating circuit further comprises a light emitting (LED), the overcurrent output terminal is connected to an anode of the LED via a resistor, a cathode of the LED is connected to the ground terminal of the input circuit.
